(19) United States
(12) Patent Application Publication
(10) Pub. No.: US 2022/0035181 A1
(43) Pub. Date: Feb. 3, 2022

(54) CONNECTORS FOR ATTACHING ONE OR MORE WEARABLE DEVICES TO EYEWEAR

(71) Applicant: PogoTec, Inc., Roanoke, VA (US)

(72) Inventors: RONALD D. BLUM, ROANOKE, VA (US); WALTER DANNHARDT, ROANOKE, VA (US); RICHARD CLOMPUS, TRINIDAD, CA (US); WILLIAM KOKONASKI, BELFAIR, WA (US); JEAN-NOEL FEHR, NEUCHATEL (CH); STEFAN BAUER, BERN (CH); AMITAVA GUPTA, ROANOKE, VA (US)

(21) Appl. No.: 17/202,225

(22) Filed: Mar. 15, 2021

Related U.S. Application Data
(63) Continuation of application No. 16/324,096, filed on Feb. 7, 2019, now abandoned.
(60) Provisional application No. 62/504,758, filed on May 11, 2017.
(60) Provisional application No. 62/486,773, filed on Apr. 18, 2017.
(60) Provisional application No. 62/465,131, filed on Feb. 28, 2017.
(60) Provisional application No. 62/396,405, filed on Sep. 19, 2016.
(60) Provisional application No. 62/380,649, filed on Aug. 29, 2016.
(60) Provisional application No. 62/372,422, filed on Aug. 9, 2016.

(51) Int. Cl. G02C 11/00; A45F 5/00; A44B 13/00; A45F 5/02; F16B 2/22

(52) U.S. Cl. CPC G02C 11/10; A45F 5/00; A44B 13/0005; A45F 5/02; G02C 2200/02; A45F 2005/006; A45F 2200/0533; A44D 2203/00; F16B 2/22

(57) ABSTRACT

A connector assembly comprising a base having an adapter and a retainer, the adapter configured to reversibly couple to a wearable device using a magnet, ferromagnetic material, or combinations thereof; an elastic member partially positioned within the retainer, the elastic member having a first loop portion adjacent a first end of the retainer and a second loop portion adjacent a second end of the retainer; and wherein the elastic member is configured to stretchably move with respect to the base such that, responsive to a force pulling the first loop portion over a portion of an eyewear frame, the second loop portion changes in size.

### CROSS-REFERENCE TO RELATED APPLICATIONS

This application is a continuation of U.S. patent application Ser. No. 16/324,096, filed Feb. 7, 2019, and entitled “CONNECTORS FOR ATTACHING ONE OR MORE WEARABLE DEVICES TO EYEWEAR,” which is a U.S. national phase application of PCT Application PCT/US2017/046147, filed Aug. 9, 2017, the entirety of each of which is hereby incorporated by reference.

This application claims the benefit under 35 U.S.C. 119 of the earlier filing date of U.S. Provisional Application No. 62/372,422 entitled “UNIVERSAL EYEWEAR CONNECTOR”, filed Aug. 9, 2016. The aforementioned provisional application is hereby incorporated by reference in its entirety, for any purpose.

This application claims the benefit under 35 U.S.C. 119 of the earlier filing date of U.S. Provisional Application No. 62/380,649 entitled “USER FRIENDLY UNIVERSAL EYEWEAR CONNECTOR”, filed Aug. 29, 2016. The aforementioned provisional application is hereby incorporated by reference in its entirety, for any purpose.

This application claims the benefit under 35 U.S.C. 119 of the earlier filing date of U.S. Provisional Application No. 62/396,405 entitled “ENHANCED USER FRIENDLY UNIVERSAL EYEWEAR CONNECTOR”, filed Sep. 19, 2016. The aforementioned provisional application is hereby incorporated by reference in its entirety, for any purpose.

This application claims the benefit under 35 U.S.C. 119 of the earlier filing date of U.S. Provisional Application No. 62/465,131 entitled “REFINED UNIVERSAL CONNECTOR”, filed Feb. 28, 2017. The aforementioned provisional application is hereby incorporated by reference in its entirety, for any purpose.

This application claims the benefit under 35 U.S.C. 119 of the earlier filing date of U.S. Provisional Application No. 62/486,773 entitled “ENHANCED UNIVERSAL CONNECTOR FOR EYEWEAR”, filed Apr. 18, 2017. The aforementioned provisional application is hereby incorporated by reference in its entirety, for any purpose.

This application claims the benefit under 35 U.S.C. 119 of the earlier filing date of U.S. Provisional Application No. 62/504,758 entitled “UNIVERSAL CONNECTOR FOR EYEWEAR”, filed May 11, 2017. The aforementioned provisional application is hereby incorporated by reference in its entirety, for any purpose.

### TECHNICAL FIELD

Examples described herein relate to wearable electronic devices which may be worn on eyewear. Examples of universal connectors are described which may be attached to an eyewear temple and expose an interface (e.g., a magnet and/or ferromagnetic material) that may connect with a wearable electronic device (e.g., a camera).

### BACKGROUND

The number and types of commercially available electronic wearable devices continues to expand.

Generally, eyewear may be used to alter a visual image a person may see but is devoid of electronic features.

Eyewear are available with a wide array of styles and sizes. It may be difficult to provide an electronic wearable device which may be compatible with a wide variety of eyewear.

### SUMMARY

In some embodiments, a connector assembly includes a base having an adapter and a retainer, the adapter configured to reversibly couple to a wearable device using a magnet, ferromagnetic material, or combinations thereof; an elastic member partially positioned within the retainer, the elastic member having a first loop portion adjacent a first end of the retainer and a second loop portion adjacent a second end of the retainer; and wherein the elastic member is configured to stretchably move with respect to the base such that, responsive to a force pulling the first loop portion over a portion of an eyewear frame, the second loop portion changes in size.

In some embodiments, a method of installing a universal connector on eyewear includes manipulating a first loop of an elastic member of a universal connector about a portion of eyewear; manipulating a second loop of the elastic member about the portion of eyewear; and positioning the universal connector on the eyewear.

In some embodiments, a universal connector kit for eyewear includes a retainer configured to retain a portion of an elastic member in an assembled position; an adapter configured to reversibly couple to an electronic wearable device and configured to reversibly couple with the retainer in the assembled position; at least three elastic members having different lengths; wherein in the assembled position, each of the at least three elastic members form two loops configured to be positioned about the temple of an eyewear.

### BRIEF DESCRIPTION OF THE DRAWINGS

Features, aspects and attendant advantages of described embodiments will become apparent from the following detailed description, in which:

FIG. 1 is a rear isometric view of a first embodiment of a universal connector assembly positioned on eyewear.

FIG. 2 is a rear isometric view of the universal connector assembly of FIG. 1.

FIG. 3 is a side view of the universal connector assembly of FIG. 1.

FIG. 4 is a top view of the universal connector assembly of FIG. 1.

FIG. 5 is a rear view of the universal connector assembly of FIG. 1.

FIG. 6 is a cross-sectional view along line 6-6 o the universal connector assembly of FIG. 3.

FIG. 7 is a rear isometric view of a second embodiment of a universal connector assembly.

FIG. 8 is a rear isometric view of a base of the universal connector assembly of FIG. 7.

FIG. 9 is an alternate rear isometric view of the base of FIG. 8.

FIG. 10 is a rear view of the base of FIG. 8.

FIG. 11 is a cross-sectional view along line 11-11 of the base of FIG. 9.

FIG. 12 is a rear isometric view of an elastic member of the universal connector assembly of FIG. 7.

FIG. 13 is a rear isometric view of the elastic member of FIG. 12 in a resting position.

FIG. 14 is a rear isometric view of a third embodiment of a universal connector assembly.

FIG. 15 is a rear isometric view of an elastic member of FIG. 14 in a resting position.

FIG. 16 is a rear isometric view of a fourth embodiment of a universal connector assembly.

FIG. 17 is a rear view of the universal connector assembly of FIG. 16.

FIG. 18 is a cross-sectional view along line 18-18 of the universal connector assembly of FIG. 16.

FIG. 19 is a front isometric view of a fifth embodiment of a universal connector assembly positioned on eyewear.

FIG. 20 is a rear isometric view of the universal connector assembly of FIG. 19.

FIG. 21 is a top isometric view of a sixth embodiment of a universal connector assembly positioned on eyewear.

FIG. 22 is a rear isometric view of the universal connector assembly of FIG. 21.

FIG. 23 is a rear isometric view of a visible display member.

FIG. 24 is an alternate rear isometric view of the visible display member of FIG. 23.

FIG. 25 is a rear view of the visible display member of FIG. 23.

FIG. 26 is an isometric view of a universal connector assembly in a first position.

FIG. 27 is an isometric view of the universal connector assembly of FIG. 26 in a second position.

FIG. 28 is a method of installing a universal connector assembly on eyewear.

### DETAILED DESCRIPTION

Examples described herein include devices, methods, and systems for the connection or coupling of wearable devices, including electronic wearable devices (EWDs), to eyewear.

Any of a variety of wearable devices and/or EWDs may be used in examples described herein. A user may desire to wear any or all of the wearable and/or EWD at various times of day or occasions. Examples of wearable device and/or EWD include an augmented reality device; activity tracker; Bluetooth connection feature; buzzer; camera; communication component; computer; computer; display; fitness tracker; flash, image capture device; image sensor; laser; light; microphone; mixed reality device; name tag; reflector; sign; sensors; speaker; transceiver; vibrator; virtual reality device; watch, and WiFi connection feature. The sensor may include an accelerometer; acoustic sensor; air pressure sensor; air quality sensor; altimeter; bio sensor; CO sensor; CO2 sensor; electro-mechanical sensor; an EMG sensor; GPS sensor; gyroscope; humidity sensor; infrared sensor; light sensor; mechanical sensor; micro-gyroscope; odor sensor; oxygen sensor; pedometer; pressure sensor; pulse rate sensor; radiation sensor; spectrometer; sweat sensor; temperature sensor; tilt switch; UV sensor; a sensor capable of measuring a base solution, neutral solution, or acidic solution; and/or other sensors. In some examples, the sensor may include application information and programming configured to calculate a user's caloric expenditures, distance traveled, time slept, and quality of sleep.

Configuring the EWD to detachably couple, connect, secure, or attach to eyewear may represent manufacturing challenges as there is not a standard size or shape for eyewear. Eyewear may come in a variety of styles, sizes, shapes, with a variety of temple hinges and layouts to connect the temples to the lens frame. The lens frame and temples may have a variety of thicknesses, vertical heights, lengths, styles and shapes. In some examples, the lens frame or temple may have jewelry or logos that a user desires to remain uncovered. It may be challenging to design an EWD to connect to eyewear because of the variety of combinations of EWTD, lens frame, and eyewear temples.

Furthermore, different users may desire to position the EWD at different places on the eyewear. In some examples, a user may position the EWD near the lens or eye wire portion of the eyewear. In some examples, a user may position the EWD on the temple near the lens or eye wire portion of the eyewear. The temple shape at this location may be narrow or wide, round, square or oblong-shaped, have a constant thickness or taper, or other configurations. In some examples, a user may desire to position the EWD in the middle of the temple. In some examples, a user may desire to position the EWD near the rear of the temple such as the temple tip, the earpiece, or the end tip. The temple shape at this location may be curved or straight, have a constant thickness or taper, be narrow or wide, be formed to increase the comfort to the user, or other configurations. In some examples, a user may move the EWD to various positions along the temple.

Additionally, different users may desire to position the EWD on different temples, e.g., the right or the left temple. In some examples, the right or medial and left or lateral temples may have similar shapes, or may have mirrored shapes such that an EWD configured to aim to the front of a user when positioned on the right or medial temple would aim to the back of the user when positioned on the left or lateral temple. This may be desirable in some examples, while undesirable in others.

To overcome or partially address the challenge of the coupling a variety of EWD to a variety of eyewear frame shapes and temple shapes at a variety of locations along the frame and/or temple in some examples, connector assemblies described herein may be used to detachably couple, connect, secure, or attach an EWD or multiple EWD to eyewear.

Examples described herein include apparatuses to connect EWD to eyewear. The apparatus may be a connector (e.g., assembly, universal connector, or universal connector assembly) configured to couple an EWD to eyewear. In some examples, the assembly has an elastic member and a base having an adapter and a retainer. In some examples, the retainer of the base retains the elastic member, such that the retainer is coupled, connected, attached, and/or secured to the eyewear using the elastic member. The elastic member may be a sleeve, a single loop of flexible material, or multiple loops of elastic material.

In some examples, the shape and position of the elastic member may be adjusted with respect to the retainer in response to a force applied to the elastic member. In some examples, the elastic member may be formed from a material such as a thermoplastic elastomer. In some examples, a force may be applied to the elastic member to stretch and position the elastic member so that in a first position, a first end of the elastic member forms a large loop portion near a first end of the retainer, while a second end of the elastic member contacts a second end of the retainer. The position of the second end of the elastic member allows the elastic member, in response to the applied force, to be pulled and stretched into this first positon, with the second end of the elastic member, in response to the applied force, changing in size and moving toward, pulling, pressing, contacting and/or compressing against the second end of the retainer without separating from the retainer. In this configuration, a user may grasp the first end of the elastic member to thread it about a portion of eyewear, such as the temple. Once the first end of the elastic member is positioned about the eyewear, a user may grasp or pull on the second end of the elastic member. In response to the force applied to the second end, the looped portion of the first end of the elastic member may be changed in size and pulled somewhat or fully taut around the eyewear. The user may then apply a force to elastic member to also stretch the elastic member into a second positon, forming a large loop portion at the second end of the elastic member adjacent or near the second end of the retainer. The user may then loop, manipulate, wrap, bend, and/or force the second end of the elastic member about the eyewear, thereby temporarily securing the base to the eyewear, such as an eyewear temple. In some examples, the temporary deformation or stretchability of the elastic member may allow a user to move or adjust the position of the assembly along the length of the temple and/or rotate about the temple without removing the assembly from the temple. In some examples, the temporary deformation or stretchability of the elastic member also allows the assembly to be “universally” secured to a variety of eyewear shapes, sizes and configurations. For example, one connector may be suitable for interfacing with a range of eyewear shapes and sizes.

In some examples, the adapter of the base of the assembly is configured to connect or couple the wearable device to the base. The adapter of the base may have a magnetic or ferromagnetic feature (e.g., material, plate, region) to aid in detachably coupling the wearable device to the base of the assembly. In some examples, the adapter may have a magnetic or ferromagnetic member (e.g., material, plate, region) that is configured to magnetically couple with a magnetic or ferromagnetic feature of the wearable device. In some examples, the magnetic member of the adapter may be positioned within the base using an at least partial overmold technique. A cavity may be formed by the magnetic member, an aperture, and a lateral surface (in the examples where the assembly is positioned on the lateral temple). In some examples, the wearable device has a protrusion configured to be positioned within the cavity and shaped to complement the shape of the cavity. In some examples, the protrusion of the wearable device is magnetic or ferromagnetic.

In some examples, a non-electronic sign or a visible display member may be configured to detachably couple to the assembly. The visible display member may have a protrusion similar to the protrusion on the EWD such that the visible display member protrusion is configured to be positioned within the cavity. The visible display member may also have a magnetic or ferromagnetic feature configured to magnetically couple with the magnetic or ferromagnetic member of the adapter of the base of the assembly. The visible display member may be used to identify the universal connecting assembly and its features to a user.

For purposes of description, note that eyewear may have a lateral temple, lenses, a bridge connecting the lenses, and a medial temple. Throughout this description, reference directions of anterior-posterior, lateral-medial, and upward-downward may be used. The anterior direction references the direction towards the front of a user or their face such that lenses of eyewear may positioned in the anterior direction when the eyewear is worn and the bridge positioned on or above the nose of the user. The posterior direction references the direction towards the back of the user's head such that the temple tips extend in the posterior direction when the eyewear is worn and the bridge is positioned on or above the nose of the user. The lateral direction may reference a user's left side such that the left temple is positioned on the lateral side when the eyewear is worn and the bridge is positioned on or above the nose of the user. The medial direction may reference a user's right side such that the right temple is positioned on the medial side when the eyewear is worn and the bridge is positioned on or above the nose of the user. The upward direction is the direction extending up past a user's head, and the downward direction is the direction extending down towards a user' s feet.

The directions are for reference only and it is contemplated that the eyewear may be worn in other configurations and positions that may alter the reference directions, such as when the eyewear is positioned on the crown of the user's head, similar to the positon of a headband, or the eyewear is in a stored position with the temples of the eyewear folded inward. The universal connector assembly described herein may be generally described in some examples as being positioned on the lateral temple, although it is contemplated that in some examples it may be positioned on the medial temple.

While particular examples described herein may refer, for example, to a magnet on a wearable device and a ferromagnetic material (and/or other magnet-attracting material) exposed by a connector assembly which allows the wearable device to connect to the connector assembly through magnetic attraction, it is to be understood that the incorporation of magnets and/or magnet-attracting materials are interchangeable in examples as between the wearable device and connector assembly. For example, the wearable device may include a ferromagnetic material (and/or other magnet-attracting material) and the connector assembly may include a magnet in some examples. In some examples, both the wearable device and the connector assembly may include respective magnets which may attract one another during use. In some examples, the magnetic or ferromagnetic material is steel or stainless steel. In some examples, the stainless steel may be in a hardened condition, or martensitic, to have an appropriate level of magnetic attraction, such as a 400 series stainless steel. In some examples, the stainless steel is AISI 410, 420, 430 or 440 grade.

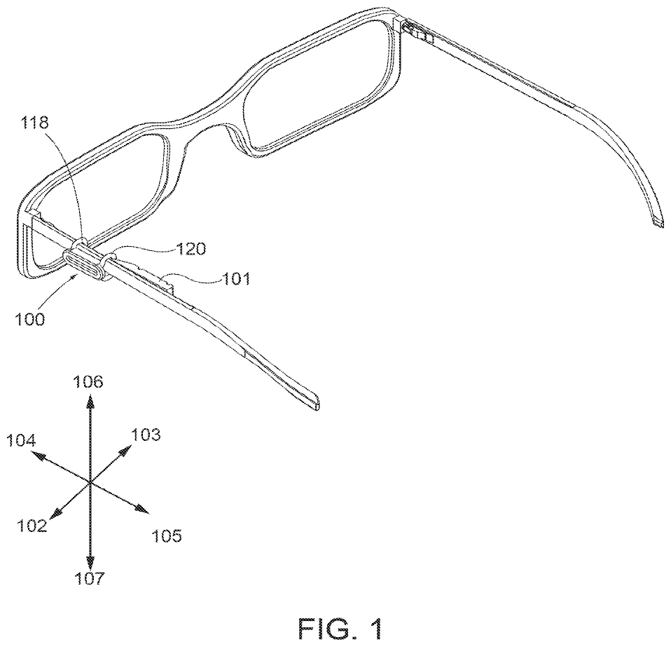

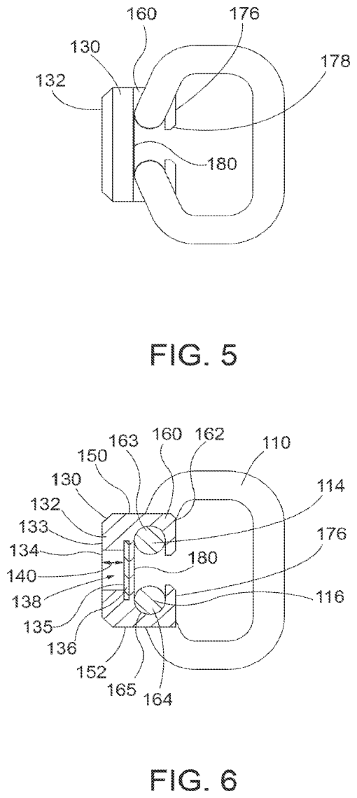

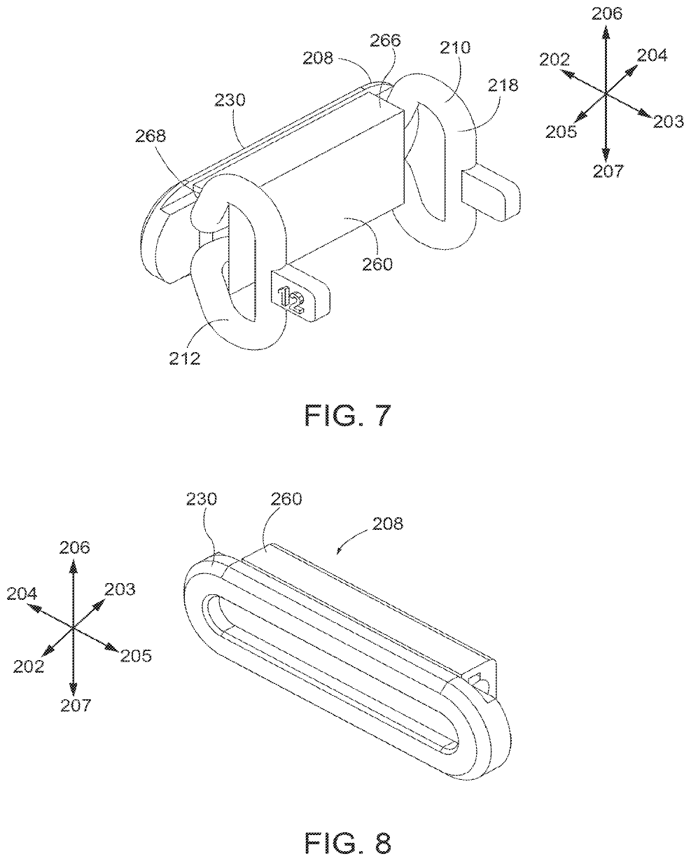

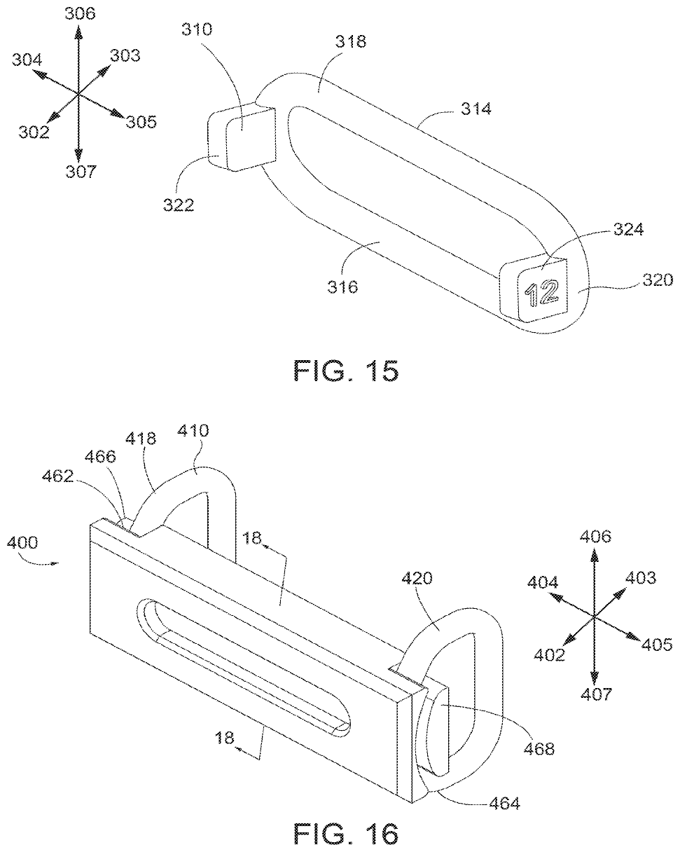

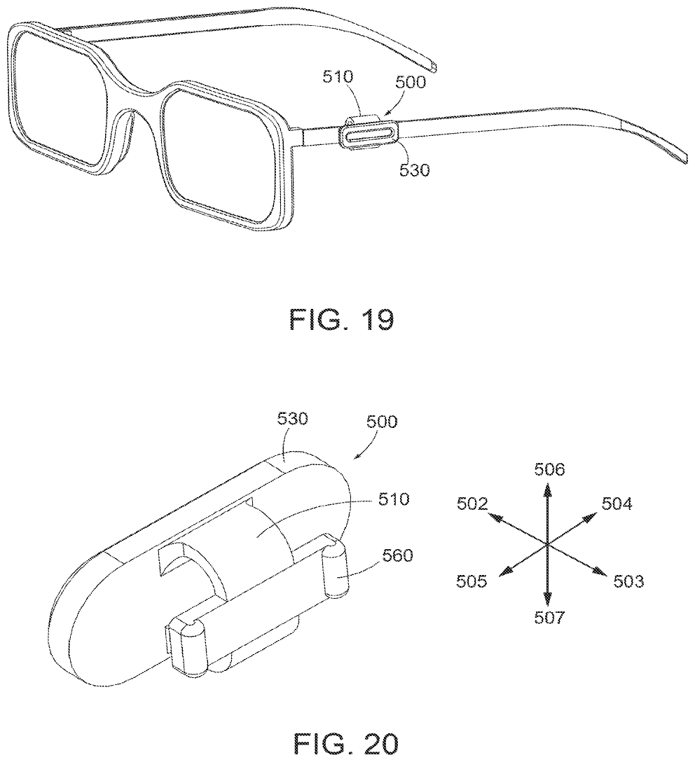

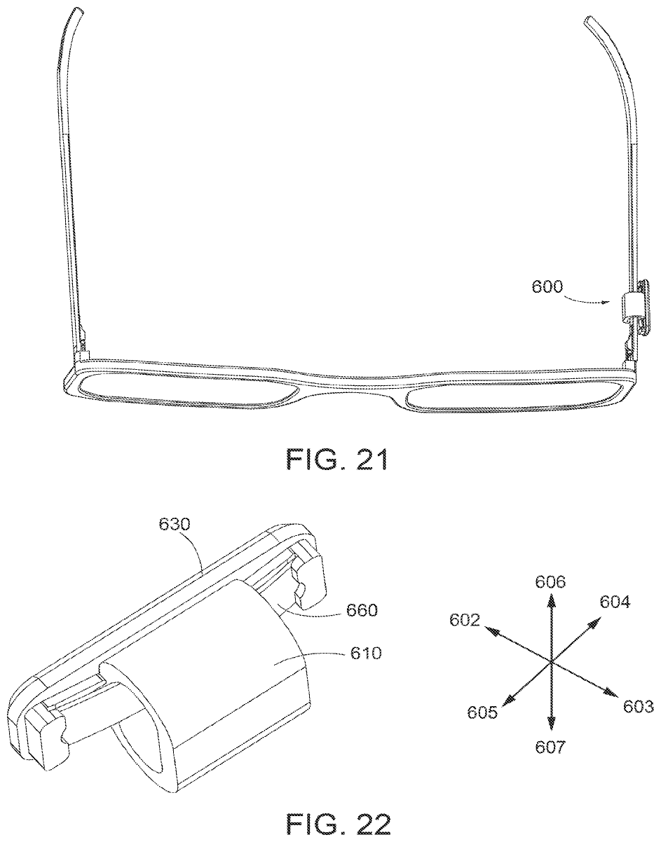

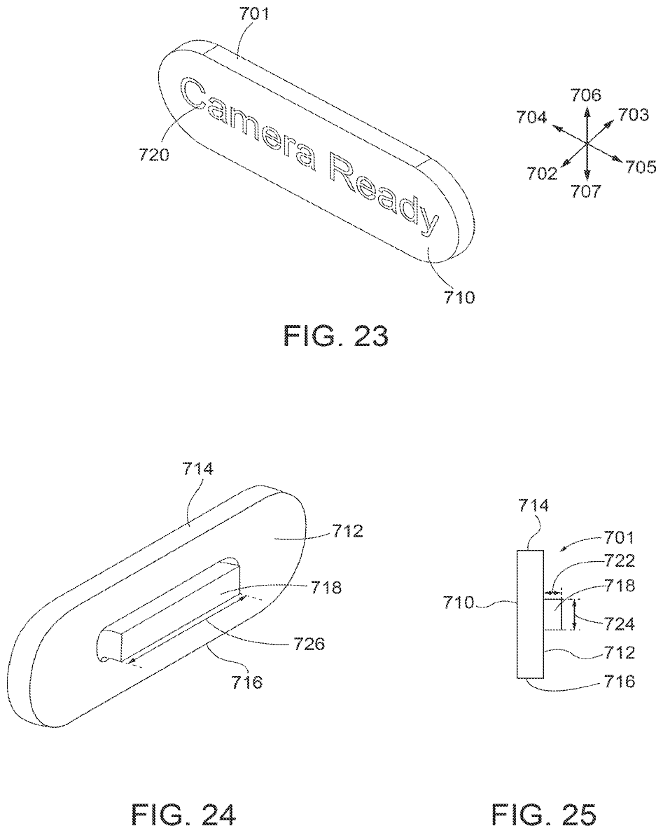

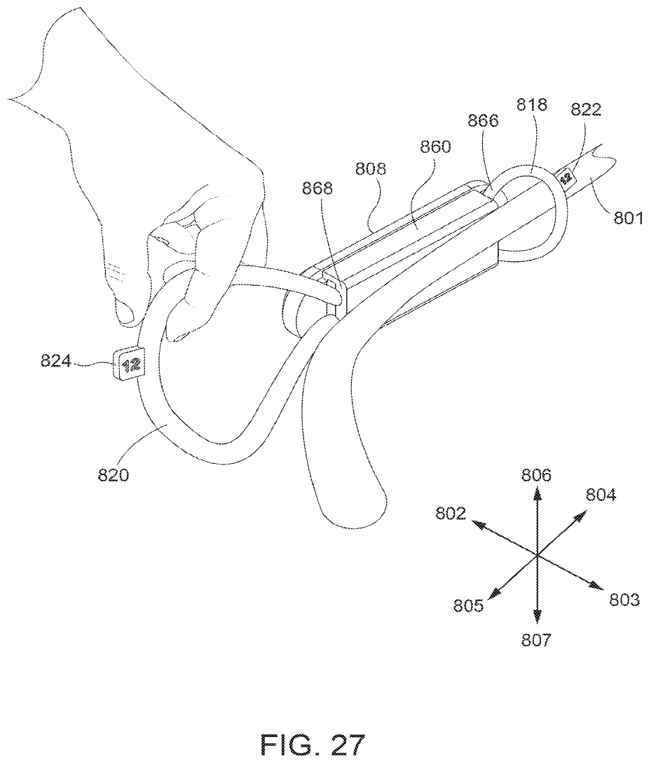

FIGS. 1-6 show a first embodiment of a universal connector assembly and its various components. FIGS. 7-13 show a second embodiment of a universal connector assembly and its various components. FIGS. 14-15 show a third embodiment of a universal connector assembly and its various components. FIGS. 16-18 show a fourth embodiment of a universal connector assembly and its various components. FIGS. 19-20 show a fifth embodiment of a universal connector assembly and its various components. FIGS. 21-22 show a sixth embodiment of a universal connector assembly and its various components. FIGS. 23-25 show a visible display member. FIGS. 26-27 show a sixth embodiment view of a universal connector assembly.

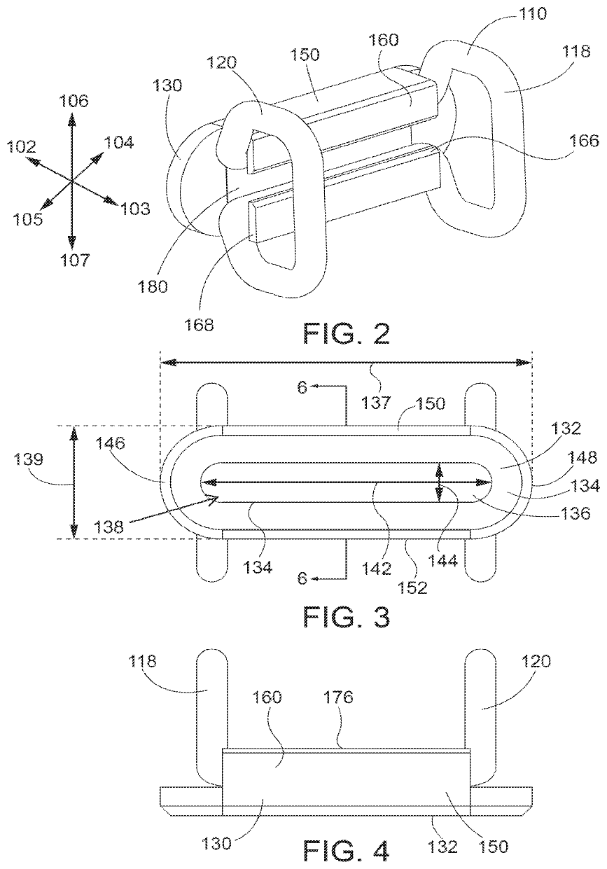

FIGS. 1-6 show a first embodiment of a universal connector assembly and its various components. FIG. 1 is a rear isometric view of a first embodiment of a universal connector assembly 10 positioned on eyewear. FIGS. 2-5 are a rear isometric, side, top, and rear view of the universal connector assembly 100 of FIG. 1. FIG. 6 is a cross-sectional view along line 6-6 of the universal connector 100 assembly of FIG. 3.

A reference axes system applies to FIGS. 1-6 as follows: a lateral direction 102, a medial direction 103, an anterior direction 104, a posterior direction 105, an upward direction 106, and a downward direction 107.

In some examples, the universal connector assembly 100 has an elastic member 110, and a base 108 having an adapter 130 and a retainer 150. The adapter 103 may include an aperture 134 positioned in a lateral surface 133 of a lateral wall 132. The aperture 134 may extend between an anterior end 146 and a posterior end 148 of the adapter 130, and extend in the anterior-posterior directions 104, 105. In some examples, the aperture 138 is generally rectangular shaped, with rounded ends adjacent the anterior end 146 and the posterior end 148.

As shown in FIG. 6, the aperture 134 extends through the lateral wall 132 to form a cavity 138. A base 135 of the cavity 138 may be formed by a magnetic or ferromagnetic member 136. A depth 140 of the cavity 138 extends in the lateral-medial directions 102, 103 and is a distance between lateral surface 133 and the magnetic member 136. As shown in FIG. 2, a height 144 of the cavity 138 extends in the upward-downward directions 106, 107 and is general]}′ the height of the aperture 134, and less than an overall height 139 of the adapter 130. A length 142 of the cavity 138 extends in the anterior-posterior directions 104, 105 and is generally the length of the aperture 134, and less than an overall length 137 of the adapter 130.

In some examples, the magnetic member 136 is ferromagnetic or magnetic, and may be formed from iron, nickel, cobalt, steel, stainless steel, alloy of steel comprising a ferromagnetic material, or combinations thereof. In some examples, stainless steel may be in a hardened condition, or martensitic, to have an appropriate level of magnetic attraction, such as a 400 series stainless steel. In some examples, the stainless steel is AISI 410, 420, 430 or 440 grade. As shown in FIG. 6, in some examples, the magnetic member 136 is shaped to have a larger height and width than the height 144 and length 142 of the cavity 138. This may prevent the magnetic member 136 from being removed or dislodged through the cavity 138. In some examples, the magnetic member 136 is at least partially overmolded with a material, such as plastic or similar material to form the adapter 130, the retainer 160, or the base 108. In some examples, portions of adapter 130, the retainer 160, and/or the base 108 are formed from a polymer. In some examples, the polymer is formed of at least acetal polymer, stabilizer, and formaldehyde, such as presently available as DELRIN from Dupont. In some examples, the magnetic member 136 is a plate with a thickness in the general range of 0.4 mm to 0.8 mm. In some examples, the magnetic member 136 is a plate with a thickness in the general range of 0.5 mm to 0.6 mm. In some examples, the magnetic member 136 is configured to magnetically couple with a magnetic or ferromagnetic feature of the wearable device. A magnetic attraction force, in part based upon the thickness of the 136, may be generated between the magnetic member 136 and a magnetic or ferromagnetic feature of the wearable device. The magnetic attraction force may be sufficient to hold the wearable device with the assembly but weak enough to allow for the removal of the wearable device from the assembly. If the magnetic attraction force is too small, the wearable device may become easily dislodged or separated from the assembly when the dislodging or separation is not desired by the user. If the magnetic attraction force is too large, reversibly coupling the wearable device with the assembly may cause the eyewear to be disturbed when worn by a user. For example, if the force is too large, when the user grasps a camera reversibly coupled to the assembly to remove the camera, the camera may not easily decouple and the movement would also cause the assembly and an eyewear temple the assembly is coupled with to also move or shift. In some examples, an acceptable range of magnetic attraction force may be generally between 3 N-10 N. In some examples, an acceptable range of magnetic attraction force may be generally between 3 N-8 N.

In some examples, the base 108 may have an upper wall 152 extending in the lateral, medial directions 102, 103, and a lower wall 154 extending in the lateral, medial directions 102, 103. The upper wall 152 may be positioned in the upper direction 106 and the lower wall 154 may be positioned in the lower direction 107 relative to the assembly 100. The upper wall 152 and lower wall 154 may be generally parallel with each other. The lateral surface 133 of the lateral wall 132 may be generally perpendicular to the upper wall 152 and lower wall 154. In some examples, the upper wall 152 and lower wall 154 form a portion of the adapter 130 and the retainer 160.

As shown in FIG. 6, in some examples, the retainer 160 has an anterior end 166 and a posterior end 168, with an overall length extending in the anterior-posterior directions 104-105. The retainer 160 may have an upper chamber 162 and a lower chamber 164 that each extend from the anterior end 166 to the posterior end 168. An intermediate wall 180 forms a portion of the upper chamber 162 and the lower chamber 164. The intermediate wall 180 may be positioned between and generally parallel to the lateral wall 132 of the adapter 130 and a medial wall 176 of the retainer 160. The medial wall 176 forms a portion of the upper chamber 162 and the lower chamber 164. An aperture 178 extends through the medial wall 176 in the lateral direction 102 and allows access to the upper chamber 162 and the lower chamber 164. The aperture 178 extends from the anterior end 166 to the posterior end 168 of the retainer 160. In some examples, the upper chamber 162 is not enclosed in the downward direction 107, and the lower chamber is not enclosed in the upward direction 106.

In some examples, the upper chamber 162 is configured to allow the placement of an upper section 114 of the elastic member 110, wherein the elastic member 110 is partially fed through the aperture 178. The lower chamber 164 is configured to allow the placement of a lower section 116 of the elastic member 110, wherein the elastic member 110 is partially fed through the aperture 178. In some examples, an upward portion 163 of the upper chamber 162 and a downward portion 165 of the lower chamber 164 may be at least partially rounded, such as up to 180 degrees, to allow the elastic member 110 to generally seat within the upper and lower chambers 162, 164. The rounded shape of the chambers 162, 164 may also allow the elastic member to be moved with respect to the retainer 160 of the base 108 without damage to the elastic member 110. Portions of the elastic member 110 may be stretched, slid, manipulated, rotated, and/or twisted within the upper and lower chambers 162, 164 when the assembly 100 is being installed or removed on eyewear, such as an eyewear temple, or when the assembly 100 is being repositioned on eyewear, such as a temple.

The elastic member 110 is configured to be manipulated to couple with the base 108. In some examples, the elastic member 110 may be formed from a generally oval-shaped member with a circular cross-section (as shown in FIG. 6) and a resting perimeter. In some examples, the cross-section of the elastic member may have a diameter between 1 mm to 2 mm. The elastic member 110 is formed from a flexible material such as rubber or other similar materials. When installed on an eyewear temple, as shown in FIGS. 1-6, or in some examples in a resting position, the elastic member 110 may form two loop portions. A first loop portion 118 is positioned adjacent to the anterior end 166 of the retainer 160. The second loop portion 120 is positioned adjacent to the posterior end 168 of the retainer 160. In some examples, a portion of eyewear, such as a temple, may then be fed through the first loop portion 118 and second loop portion 120. In some examples, the internal radius of the loop portions may be generally in between a range 1.5 mm and 3.5 mm. In some examples, the internal radius of each loop portion is 2.25 mm. The elastic member 110 is configured to flexibly or adjustably secure the assembly 100 to the temple.

In some examples, the elastic member may be formed from a material such as rubber. In some examples, the elastic member may be formed from a material such as a thermoplastic elastomer. In some examples, the elastic member may be formed from a material similar to: the presently available TC7CEN series, TF7BNA series, TF7TAA series, or TC7GPZ series of Thermolast from Kraiburg TPE Corporation; an aromatic polyether-based thermoplastic polyurethane mixture similar to the presently available 58311 NAT 022/028, a version of Estane from Lubrizol Corporation; the presently available 753 series of Empilon from HO TAI Industrial Co., or combinations thereof. The material selection of the elastic member allows the perimeter of the elastic member to be temporarily stretched from a resting length to a larger length, such as a stretched length or an installed length. The perimeter of the stretched length may be sized to allow for the assembly to be installed on eyewear without permanent damage to the elastic member. The installed length may be between the stretched length and the resting length. The installed length would correspond to the required spring forces within the elastic member to hold the assembly in a desired position when the assembly is coupled to the eyewear, but still allow the assembly to be moved with respect to or removed from the eyewear. In some examples, the resting length of the internal length of the elastic member may be generally in the range of 15 mm to 30 mm. In some examples, the resting length of the internal length of the elastic member may be 19 mm. In some examples, the resting length of the internal length of the elastic member may be 21 mm. In some examples, the resting length of the internal length of the elastic member may be 23 mm. In some examples, the resting length of the internal length of the elastic member may be 26 mm.

In some examples, when the elastic member is assembly with the base, the elastic member has a first loop portion with a first perimeter and a second loop portion with a second perimeter. When the assembly is not installed on eyewear, for example a temple, the first perimeter and the second perimeter may be smaller than a circumference of the temple. When the assembly is installed about the eyewear temple, the first perimeter and the second perimeter are stretched and changed in size, in response to the forces applied to the elastic member, so that they are larger than the perimeter of the eyewear temple. The elastic member 110 may be temporarily stretched, compressed, and/or generally deformed when the assembly 100 is installed about the eyewear temple. Once installed about the eyewear temple, the forces within the elastic member 110 created by the elastic deformation, stretching, or flexing of the elastic member 110 about the perimeter of the eyewear temple help maintain the position of the assembly 100 about the eyewear temple.

As shown in FIG. 1, in some examples, a wedge 101 may be positioned on a medial side of a lateral temple of an eyewear such that the second loop portion 120 is positioned about the lateral temple and the wedge 101. The positon of the loop portion 120 about the lateral temple and wedge 101 may cause the elastic member 110 to stretch and thereby increase the compressive forces created within the elastic member 110 acting upon the eyewear temple and the wedge 101. The use of the wedge 100 may allow an elastic member 110 of a standard length to be used with a larger variety of eyewear having various shapes. In some examples, the first loop portion 118 may also be positioned about the wedge.

In some examples where the assembly is configured to be installed about a temple, the elastic member 110 may have a variety of overall lengths to accommodate a range of temple shapes and sizes. Some examples of elastic member lengths include 19, 21, 23, or 26 mm.

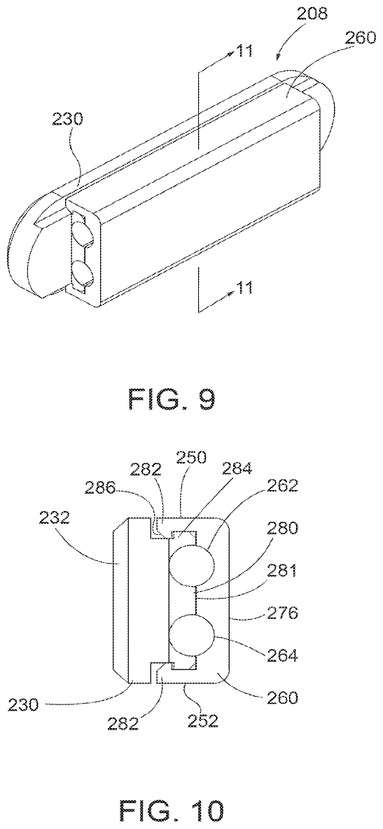

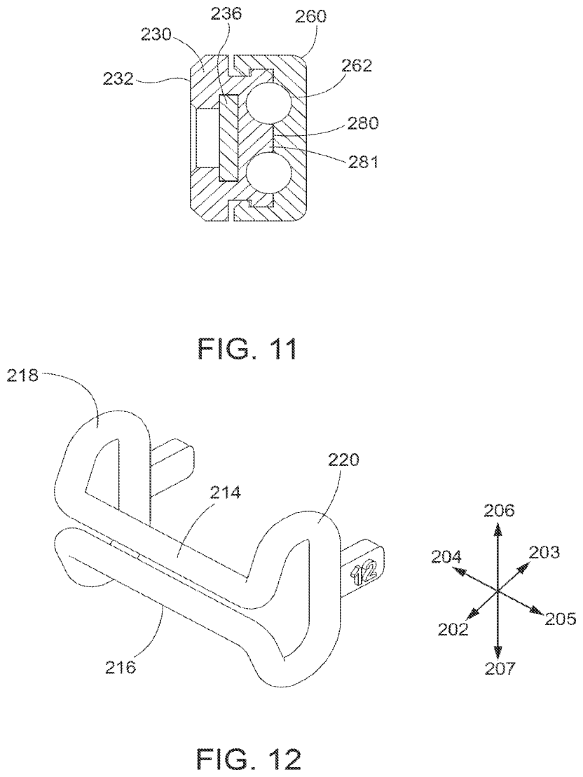

FIGS. 7-13 are various views of a second embodiment a universal connector assembly 200. FIG. 7 is a rear isometric view of a second embodiment of a universal connector assembly 200. FIGS. 8-10 are rear isometric views and a rear view of a base 208 of the universal connector assembly 200 of FIG. 7. FIG. 11 is a cross-sectional view along line 11-11 of the base 208 of FIG. 9.

Similar to FIGS. 1-6, a reference axes system applies to FIGS. 7-13 as follows: a lateral direction 202, a medial direction 203, an anterior direction 204, a posterior direction 205, an upward direction 206, and a downward direction 207. The universal connector assembly 200 may in some examples be used to implement and/or may be implemented by the universal connector assembly 100 of FIGS. 1-6. The universal connector assembly 200 may be similar to the universal connector assembly 100 of FIGS. 1-6.

Similar to the universal connector 100 of FIGS. 1-6, the universal connector 200 has an elastic member 210 and a base 208 having an adapter 230 and a retainer 260. As shown in FIG. 11, unlike the assembly 100, the adapter 230 is a separate piece from the retainer 260. The adapter 230 may have a magnetic member 236 positioned in the medial direction 203 from a lateral wall 232. The magnetic member 236 may be magnetic or ferromagnetic and configured to magnetically attract or be magnetically attracted to a magnetic or ferromagnetic feature of the wearable device. An intermediate wall 280 may form a medial edge of the adapter 230. An intermediate wall 281 may form a lateral edge of the retainer 260. In some examples, an enclosed upper chamber 262 and an enclosed lower chamber 264 are formed between the intermediate walls 280, 281. The upper chamber 262 may differ from the upper chamber 162 of assembly 100 in that the upper chamber 262 is enclosed in the lateral, medial directions 202, 203 and the upward-downward directions 206, 207. The lower chamber 264 may differ from the lower chamber 164 of assembly 100 in that the lower chamber is enclosed in the lateral, medial directions 202, 203 and the upward, downward directions 206, 207. The upper chamber 262 and lower chamber 264 may have a generally circular cross-section that is similarly shaped to portions of the elastic member 210.

In some examples, the retainer 260 and adapter 230 are coupled together. An upper wall 250 and lower wall 252 of the retainer 260 may have clips 282 configured to couple with protrusions 284 of the adapter 230. In some examples, the clips 282 extend from the upper and lower walls 250, 252 inward towards a center of the assembly. The adapter 230 has two protrusions 284 that extend outward (in the upward-downward directions 106, 107) from horizontal surfaces that are adjacent to the intermediate wall 280. When assembled, an angled edge 286 of each clip 282 contacts the protrusions 284 and may be flexed outward (upward, downward directions 106, 107) as the retainer 260 is moved in the lateral direction 202 towards the adapter 230. As the retainer 260 is moved closer in the lateral direction 202, the protrusion 284 of the adapter 230 is positioned on a medial side of the clip 282 such that the protrusion 284 is no longer forcing the clip 282 to flex outward. When in this position, the clips 282 flex back inwards (towards the center of the assembly) about the protrusions 284 to couple the retainer 260 and the adapter 230. The position of the clips 282 and the protrusions 284 couples the retainer 260 and adapter 230 together to help form the assembly 200.

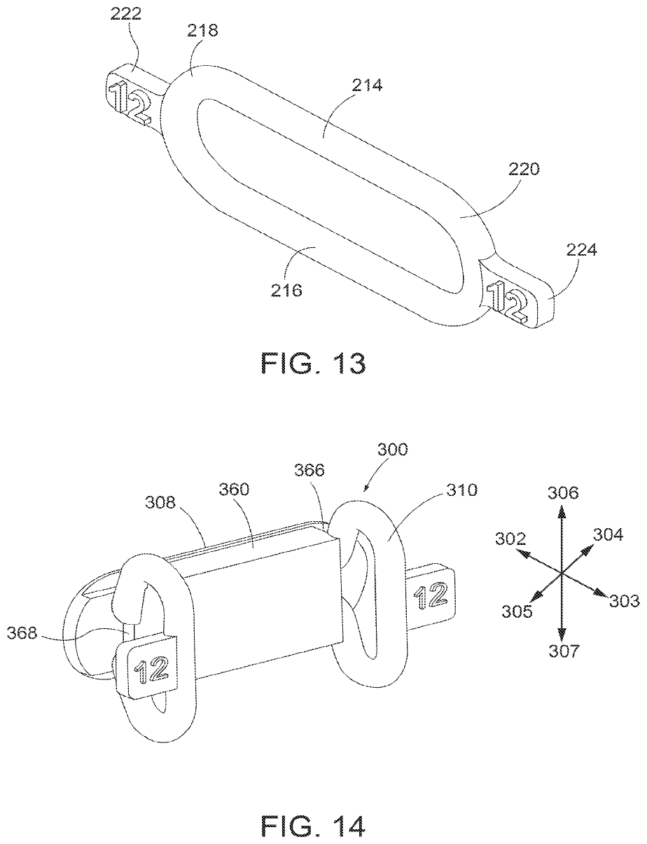

FIG. 12 shows the elastic member 210 of the universal connector assembly 200 of FIG. 7, when installed within the base 208 and positioned about a portion of eyewear, such as a left temple. FIG. 13 is a rear isometric view of the elastic member of FIG. 12 positioned in a resting position.

As shown in FIG. 13, the elastic member 210 may have a generally oval-shaped perimeter when positioned in a resting position. In other examples, the elastic member 210 may have a circular or oblong-shaped perimeter. As shown in FIG. 13, the oval-shaped elastic member 210 may have a first loop portion 218 connected to an upper section 214 connected to a second loop portion 220 connected to a lower section 216 connected to the first loop portion 218. In some examples, a first tab 222 extends away from the first loop portion 218 and a second tab 224 extends away from the second loop portion 220. In some examples, the tabs 222, 224 may be generally planar with the first and second loops 218, 220 and the upper and lower sections 214, 216. In some examples (see FIG. 15), the tabs 222, 224 may be positioned generally normal the first and second loops, and the upper and lower sections.

As shown in FIG. 7, when positioned within the retainer 260 and installed on an eyewear, such as a left temple, the first loop portion 218 is positioned adjacent to the anterior end 266 of the retainer 260, and aligned generally in the lateral, medial directions 202, 203. The second loop portion 220 is positioned adjacent to the posterior end 268 of the retainer 260 and aligned generally in the lateral, medial directions 202, 203. When the elastic member 210 is installed within the retainer 260, the upper section 214 is positioned within the upper chamber 262 and the lower section 216 is positioned within the lower chamber 264. In examples where the elastic member has tabs 222, 224, the tabs may be generally aligned in the lateral, medial directions 202, 203.

In some examples, the tabs 222, 224 may allow a user to more easily grasp the elastic member 210. This may include situations where the user is assembling the elastic member 210 within the retainer 260, or when the user is manipulating the elastic member 210 installed within the retainer 260 to position the assembly 100 on eyewear, such as an eyewear temple. A user may grasp the tab 222 to manipulate or change the size of the shape of the first loop portion 218. In response to the forces applied to the tab 222, the location of elastic member 210 with respect to the retainer 260 when the elastic member 210 is installed within the retainer 260 may be moved or altered. The user may also grasp the tab 222, and in response to the force, adjust the locations of the upper and lower sections 214, 216 positioned within the upper and lower chambers 262, 264. The user may also grasp the tab 222 so that, in response to the force, the upper and lower sections 214, 216 stretch within the upper and lower chambers 262, 264. The user may also grasp the tab to force or positon the second loop 220 against the posterior end 268 of the retainer 260.

In some examples where the first loop portion 218 is positioned about the temple, the user may then grasp the tab 224 and tension the first loop portion 218 about the temple. In response to the force applied, the elastic member may shift with respect to the retainer 260, with the upper and lower portions 214, 216 and the second loop portion 220 being stretched in the posterior direction 205. The user may continue to grasp the tab 224 to stretch, manipulate, and/or positon the second loop 220 about the temple, thereby adjustably securing the retainer 260 to the temple.

FIGS. 14-15 show a third embodiment of a universal connector assembly 300 and its various components. FIG. 14 is a rear isometric view of a third embodiment of the universal connector assembly 300. FIG. 15 is a rear isometric view of the elastic member 310 of FIG. 14 in a resting position. Similar to FIGS. 1-6, a reference axes system applies to FIGS. 14-15 as follows: a lateral direction 302, a medial direction 303, an anterior direction 304, a posterior direction 305, an upward direction 306, and a downward direction 307. The universal connector assembly 300 may in some examples be used to implement and/or may be implemented by the universal connector assemblies 100, 200 of FIGS. 1-13. The universal connector assembly 300 may be similar to the universal connector assemblies 100, 200 of FIGS. 1-13.

FIG. 15 shows the elastic member 310 in a resting positon. The elastic member 310 is similar to the elastic member 210 of FIG. 13, in that first and second loop portion 318, 320 and upper and lower section 314, 316 are generally planar. The elastic member 310 differs from the elastic member 210 as tabs 322, 324 extend in a generally normal direction away from the first and second loop portions 318, 320 and the upper and lower sections 314, 316.

As shown in FIG. 14, when the elastic member 310 is positioned within the retainer 260 and installed on an eyewear, such as the left temple of FIG. 1, the first loop 318 is positioned adjacent to the anterior end 368 of the retainer 360, and aligned generally in the lateral, medial directions 302, 303. The second loop portion 320 is positioned adjacent to the posterior end 368 of the retainer 360 and aligned generally in the lateral, medial directions 302, 303. As shown in FIG. 14, the tabs 322, 324 of the elastic member 310 are generally aligned in the anterior, posterior directions 304, 305.

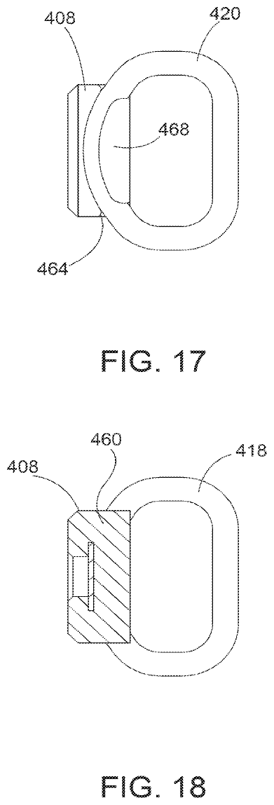

FIGS. 16-18 show a fourth embodiment of a universal connector assembly and its various components. FIG. 16 is a rear isometric view of a fourth embodiment of a universal connector assembly. FIG. 17 is a rear view of the universal connector assembly of FIG. 16. FIG. 18 is a cross-sectional view along line 18-18 of the universal connector assembly of FIG. 16.

Similar to FIGS. 1-6, a reference axes system applies to FIGS. 16-18 as follows: a lateral direction 402, a medial direction 403, an anterior direction 404, a posterior direction 405, an upward direction 406, and a downward direction 407. The universal connector assembly 400 may in some examples be used to implement and/or may be implemented by the universal connector assemblies 100, 200, 300 of FIGS. 1-15. The universal connector assembly 400 may be similar to the universal connector assemblies 100, 200, 300 of FIGS. 1-15.

In some examples, the universal connector assembly 500 of FIGS. 16-18 may differ from the universal connector assembly 100, 200, 300 of FIGS. 1-15 in that the elastic member 410 is formed from two individual loop portions 418, 420. The loop portions 418, 420 may be formed from a material similar to the material of elastic members 110, 210, 310. The loop portions 418, 420 may extend generally in the lateral, medial directions 402, 403. The universal connector assembly 500 has a retainer 460 with an anterior chamber 462 positioned on an anterior end 466 and a posterior chamber 464 positioned on a posterior end 468. The anterior chamber 462 may extend in the posterior direction 405 a depth similar to a thickness of the loop 418, and be sized and shaped to complement the shape of the loop 418. The posterior chamber 464 may extend in the anterior direction 404 a depth similar to a thickness of the loop 420 and be sized and shaped to complement the shape of the loop 420. The anterior and posterior chambers 462, 464 may extend vertically in the upward, downwards directions 406, 407.

FIGS. 19-20 show a fifth embodiment of a universal connector assembly and its various components. FIG. 19 is a front isometric view of a fifth embodiment of a universal connector assembly 500 positioned on eyewear. FIG. 20 is a rear isometric view of the universal connector assembly 500 of FIG. 19.

Similar to FIGS. 1-6, a reference axes system applies to FIGS. 19-20 as follows: a lateral direction 502, a medial direction 503, an anterior direction 504, a posterior direction 505, an upward direction 506, and a downward direction 507. The universal connector assembly 500 may in some examples be used to implement and/or may be implemented by the universal connector assemblies 100, 200, 300, 400 of FIGS. 1-18. The universal connector assembly 500 may be similar to the universal connector assemblies 100, 200, 300, 400 of FIGS. 1-18.

In some examples, the universal connector assembly 500 differs from the universal connector assemblies 100, 200, 300 in that an adapter 530 is coupled to a retainer 560 via an elastic member 510. In some examples, the elastic member 510 may be formed at least partially by a rubber sleeve. The retainer 560 may generally extend in the anterior, posterior directions 504, 505. In an installed positon, such as that shown in FIG. 19, the retainer 560 is configured to be positioned on a medial side of the left temple. The adapter 530 is positioned on a lateral side of the left temple.

FIGS. 21-22 show a sixth embodiment of a universal connector assembly and its various components. FIG. 21 is a top isometric view of a sixth embodiment of a universal connector assembly positioned on eyewear. FIG. 22 is a rear isometric view of the universal connector assembly of FIG. 21.

Similar to FIGS. 1-6, a reference axes system applies to FIGS. 21-22 as follows: a lateral direction 602, a medial direction 603, an anterior direction 604, a posterior direction 605, an upward direction 606, and a downward direction 607. The universal connector assembly 600 may in some examples be used to implement and or may be implemented by the universal connector assemblies 100, 200, 300, 400, 500 of FIGS. 1-20. The universal connector assembly 600 may be similar to the universal connector assemblies 100, 200, 300, 400, 500 of FIGS. 1-20.

As shown in FIG. 22, in some examples, the universal connector assembly 600 has an adapter 630, a retainer 660, and an elastic member 610. The retainer 660 may extend generally in the anterior, posterior directions 604, 605 and is configured to couple with protrusions on a medial side of the adapter 630. In some examples, the elastic member 610 may be coupled to the retainer 660, or coupled to the adapter 630, or may be clamped between the retainer 660 and the adapter 630. In some examples, the elastic member 610 may be a rubber sleeve and be configured to flex and stretch to accommodate various shapes of the eyewear, such as the temple.

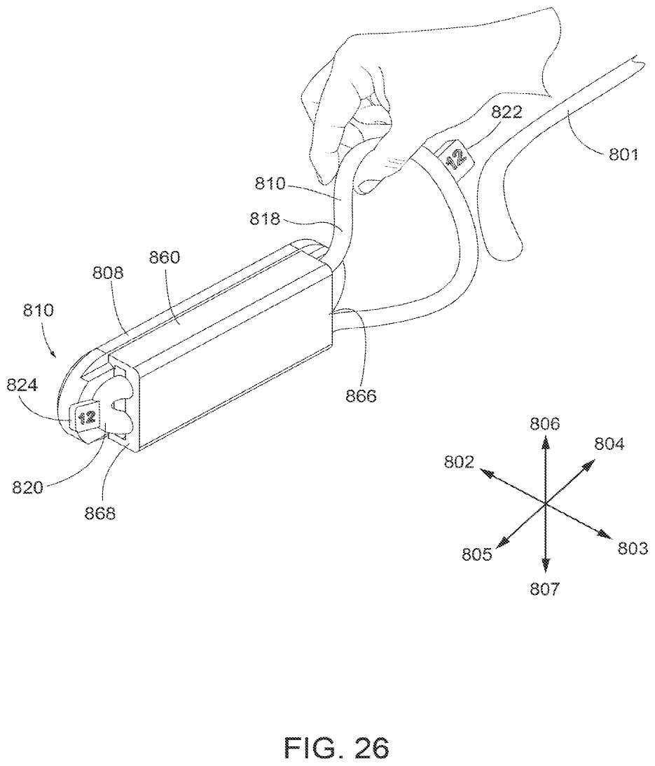

FIGS. 23-25 show a visible display member 701. FIG. 23 is a rear isometric view of a visible display member 701. FIG. 24 is an alternate rear isometric view of the visible display member 701 of FIG. 23. FIG. 25 is a rear view of the visible display member 701 of FIG. 23.

A reference axes system applies to FIGS. 23-25 as follows: a lateral direction 702, a medial direction 703, an anterior direction 704, a posterior direction 705, an upward direction 706, and a downward direction 707.

In some examples, the visible display member 701 is configured to align with an adapter of a universal connector assembly, such as the universal connector assemblies 100, 200, 300, 400, 500, 600 of FIGS. 1-22. The member 701 may have an upper surface 714 opposite a lower surface 716, a lateral side 710 opposite a medial side 712. The lateral side 710 may be configured with a label feature 720. In some examples, the label feature 720 is engraved (as shown in FIG. 23) into the lateral side 710 and extends into the member 701 in the medial direction 703. In some examples, the label feature 720 may be embossed and extend in the lateral direction 702 away from the lateral side 710.

In some examples, a protrusion 718 has a depth 722 that extends away from the medial side 712 in the medial direction 703. The protrusion 718 has a height 724 that extends in the upward, downward directions 706, 707. The protrusion has a length 726 that generally extends in the anterior, posterior directions 704, 705. In some examples, the dimensions of the protrusion 718, including the depth 722, height 724, and length 726, are shaped to complement the cavity of an adapter, such as the cavity 138 of adapter 130 of the universal connector assembly 100. The protrusion 718 may be at least partially magnetic or ferromagnetic and configured to be attracted to or to attract a magnetic member, such as the magnetic member 136 of the adapter 130 of the universal connector assembly 100.

FIGS. 26-27 show a sixth embodiment view of a universal connector assembly 800, with the universal connector assembly in a first and second position. Similar to FIGS. 1-6, a reference axes system applies to FIGS. 26-27 as follows: a lateral direction 802, a medial direction 803, an anterior direction 804, a posterior direction 805, an upward direction 806, and a downward direction 807. The universal connector assembly 800 may in some examples be used to implement and/or may be implemented by the universal connector assemblies 100, 200, 300, 400, 500, 600 of FIGS. 1-22. The universal connector assembly 800 may be similar to the universal connector assemblies 100, 200, 300, 400, 500, 600 of FIGS. 1-22.

In some examples, the universal connector assembly 800 may be installed on eyewear. As shown in FIGS. 26 and 27, the assembly 800 may be installed on a temple 801. The assembly 800 may have an elastic member 810 and a base 808 having a retainer 860. To install the assembly 800 on the temple 801, a user may first grasp a tab 822 connected to a first loop 818 of the elastic member. In response to the force applied, the elastic member 810 may be adjusted, stretched, and/or repositioned with respect to the retainer 860. The user may stretch the elastic member 810 so that a second loop 820 is positioned adjacent to and contacts a posterior end 868 of the retainer 860. In response to the force associated with grasping the tab 822, a perimeter of the first loop portion 818 may enlarged or changed in size. The user may continue to grasp the tab 822 and pull and/or stretch the first loop portion 818 in the anterior direction 804. The user may then insert an end of the temple 801 into and through the first loop portion 818.

Once the first loop portion 818 is positioned about the temple, the user may release the tab 822 and then grasp a tab 224 of the second loop portion 820 and pull the elastic member 810 in the posterior direction 805. In response to the force applied to the tab 224, the perimeter of the first loop portion 818 to become smaller or changed in size and tighten around the temple 801. The first loop 818 may then be positioned generally in the lateral, medial directions 802, 803 and surround the general diameter of the temple 801. The decrease in size of the first loop portion 818 perimeter may cause an increase in size of a perimeter of the second loop portion 820, as the elastic member 810 is repositioned with respect to the retainer 860 in response to the forces applied. As the user continues to grasp the tab 824 to stretch the second loop 820 portion, the user may then insert an end of the temple 801 into and through the second loop portion 820. The user may then release the tab 824, and the second loop portion 820 of the elastic member 801 contracts about the temple 801, thereby adjustably fixing the location of the retainer 860 of the base 808 with respect to the temple 801. Once the tab 224 is released, the general compressive forces associated with the elastic characteristics of the elastic member 810 being stretched about the temple 801 are generally distributed about the first and second loops 818, 820. In some examples, in response to these compressive forces, the assembly 800 may maintain its positon with respect to the temple, even when an EWD is coupled to assembly 100. The compressive forces may also be repeatedly overcome so that the location of the assembly 100 may be moved with respect to the temple 801 or removed and reinstalled on a different eyewear.

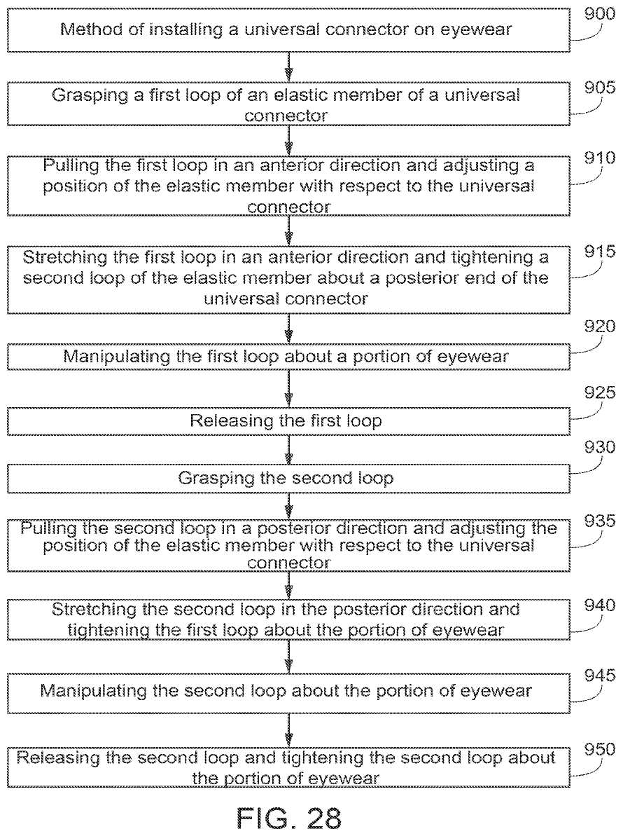

FIG. 28 is a method of installing a universal connector assembly on eyewear. In some examples, the method 900 may utilize a universal connector assembly similar to the assemblies 100, 200, 300, 400, 500, 600, 800 of FIGS. 1-22 and 26-27. The method 900 may include grasping a first loop of an elastic member of a universal connector assembly (step 905). In some examples, the next step may include pulling the first loop in an anterior direction and adjusting a position of the elastic member with respect to the universal connector assembly (step 910). In response to the forces applied to the first loop, the elastic member is repositioned with respect to the assembly.

The method may then include stretching the first loop in an anterior direction and tightening a second loop of the elastic member about a posterior end of the universal connector (step 915). The second loop may change in size in response to the force applied to the first loop. In some examples, the next step may include manipulating the first loop about a portion of eyewear (step 920).

The method 900 may also include releasing the first loop (step 925) and grasping the second loop (930). In some examples, the next steps may include pulling the second loop in a posterior direction and adjusting the position of the elastic member with respect to the universal connector (935). The method 900 may also include stretching the second loop in the posterior direction and tightening the first loop about the portion of eyewear (940). In response to the forces applied to the second loop, the first loop may be changed in size to tighten about the portion of eyewear.

In some examples, a next step may include manipulating the second loop about the portion of eyewear (945). Another step may include releasing the second loop and tightening the second loop about the portion of eyewear 950. In some examples, a visible display member may be coupled to the universal connector assembly once the method 900 is completed. In other examples, the method 900 may begin with removing a visible display member coupled to the universal connector assembly.

The above detailed description of examples is not intended to be exhaustive or to limit the method and system for wireless power transfer to the precise form disclosed above. While specific embodiments of, and examples for, the method and systems for coupling EWDs are described above for illustrative purposes, various equivalent modifications are possible within the scope of the system, as those skilled in the art will recognize. For example, while processes or blocks are presented in a given order, alternative embodiments may perform routines having operations, or employ systems having steps, in a different order, and some processes or steps may be deleted, moved, added, subdivided, combined, and/or modified. While processes or steps are at times shown as being performed in series, these processes or steps may instead be performed in parallel, or may be performed at different times. It will be further appreciated that one or more components of coupling assemblies configured to couple an EW'D with eyewear may be used in combination with any of the components or coupling assemblies of any of the examples described herein.

1. A connector assembly comprising:
a base having an adapter and a retainer, the adapter configured to reversibly couple to a wearable device using a magnet, ferromagnetic material, or combinations thereof;
an elastic member partially positioned within the retainer, the elastic member having a first loop portion adjacent a first end of the retainer and a second loop portion adjacent a second end of the retainer; and
wherein the elastic member is configured to stretchably move with respect to the base such that, responsive to a force pulling the first loop portion over a portion of an eyewear frame, the second loop portion changes in size.

2. The elastic member of claim 1, wherein a feature incorporated within the connector assembly for preventing the elastic member from being pulled completely out of the retainer when stretching one loop of the elastic member over a portion of an eyewear frame

3. The wearable device of claim 1, whereby the wearable device is electronic.

4. The wearable device of claim 1, whereby the wearable device is one of a name tag, sign, display, reflector, augmented reality device, virtual reality device, mixed reality device, light, laser, vibrator, buzzer, speaker, camera, image capture device, IR detector, radiation detector, activity tracker, Bluetooth, WiFi, transceiver, communication component, computer, display, fitness tracker, flash, image sensor, microphone, sensor, watch, accelerometer, tilt switch, acoustic sensor, air pressure sensor, air quality sensor, altimeter, bio sensor, CO sensor, CO2 sensor, electro-mechanical sensor, an EMG sensor, GPS sensor, gyroscope; humidity sensor, infrared sensor, light sensor, mechanical sensor, micro-gyroscope, odor sensor, oxygen sensor, pedometer, pressure sensor, pulse rate sensor, radiation sensor, spectrometer, sweat sensor, temperature sensor, tilt switch, UV sensor, a sensor capable of measuring a base solution, neutral solution, or acidic solution, or combinations thereof.

5. The connector assembly of claim 1, whereby the connector assembly is capable of sliding forward and backward along a length of the portion of the eyewear frame.

6. The connector assembly of claim 1, wherein the adapter has a cavity configured to reversibly couple with a male feature of the wearable device;
wherein the cavity has a length configured to allow for the male feature of the wearable device to slide forward and backward within the cavity; and
wherein the cavity has a width that is 2 mm or less wider than a width of the male feature of the wearable device.

7. The connector assembly of claim 6, wherein the length of the cavity is 2 mm or less longer than a length of the male feature of the wearable device.

8. The connector assembly of claim 1, whereby the connector assembly is configured to reversibly couple to a plurality of different shaped eyewear.

9. The connector assembly of claim 1, whereby the connector assembly is configured to reversibly couple to a plurality of different sized eyewear

10. The elastic member of claim 1, whereby the elastic member is of a round shape when not positioned within the base.

11. The elastic member of claim 1, whereby the elastic member has one tab.

12. The elastic member of claim 1, whereby a cross-section of a core of the elastic member is oval or round shaped.

13. The assembly of claim 1, further comprising:
wherein in a first position the first loop portion is larger than the second loop portion, and the second loop portion contacts the second end of the retainer;
wherein in a second position the second loop portion is larger than the first loop portion, and the first loop portion is configured to reversibly couple to the portion of the eyewear frame;
wherein in a third position the first loop portion and the second loop portion are configured to reversibly couple to the portion of the eyewear frame; and
the elastic member is configured to stretchably move with respect to the base when transitioned from the first position to the second position and from the second position to the third position.

14. The assembly of claim 1, the retainer further comprising an upper chamber generally parallel to a lower chamber and the elastic member stretchably moves within the upper chamber and the lower chamber when transitioned from the first position to the second position and the second position to the third position.

15. The assembly of claim 14, wherein the upper chamber and the lower chamber extend between the first end and the second end of the retainer.

16. The assembly of claim 15, wherein the retainer further comprises a barrier that separates the upper chamber and the lower chamber between the first end and the second end.

17. The assembly of claim 14, wherein the upper chamber and the lower chamber each have a circular cross section.

18. The assembly of claim 1, the elastic member further comprising a first tab adjacent the first loop portion and a second tab adjacent the second loop portion.

19. The assembly of claim 18, wherein the third positon, the first tab and the second tab are generally normal to the upper chamber and the lower chamber.

20. The assembly of claim 18, wherein the third positon, the first tab and the second tab are generally parallel to the upper chamber and the lower chamber.

21-37. (canceled)
